(19) United States
(12) Patent Application Publication
(10) Pub. No.: US 2024/0051847 A1
(43) Pub. Date: Feb. 15, 2024

(54) SYSTEM AND METHOD FOR REMOVAL OF MULTIPLE RECALCITRANT ORGANIC COMPOUNDS FROM WATER

(71) Applicants: Terence K. Reid, Poplar Grove, IL (US); Peter G. Baumann, Roscoe, IL (US)

(72) Inventors: Terence K. Reid, Poplar Grove, IL (US); Peter G. Baumann, Roscoe, IL (US)

(73) Assignee: Aqua-Aerobic Systems, Inc., Loves Park, IL (US)

(21) Appl. No.: 18/243,196

(22) Filed: Sep. 7, 2023

Related U.S. Application Data
(63) Continuation-in-part of application No. 16/293,251, filed on Mar. 5, 2019, now Pat. No. 11,827,537.

(51) Int. Cl. C02F 1/28

(52) U.S. Cl. CPC C02F 1/286; C02F 1/281; C02F 2303/18; C02F 2101/36

(57) ABSTRACT

The present inventions are directed to systems and methods to increase the removal of PFAS and other recalcitrant organic compound contaminants from water, and particularly ground and drinking water, using sub-micron powdered activated carbon.

### PRIORITY CLAIM

This application is a continuation-in-part and claims priority to U.S. application Ser. No. 16/293,251, filed on Mar. 5, 2019, presently allowed, which is incorporated herein in its entirety by reference.

### FIELD OF THE INVENTION

The present inventions relate to systems and methods for removing recalcitrant organic compounds, including per and poly fluoroalkyl substances, from water. In particular, the present inventions relate to systems and methods for removing such contaminants from water using sub-micron powdered activated carbon in conjunction with ceramic membrane filtration. The present inventions also relate to systems and methods for the concentration and removal of the exhausted carbon.

The present inventions also relate to systems and methods for removing multiple recalcitrant organic compounds and their co-contaminants from water using a single reactor supporting multiple adsorbents which may include different material combinations of sub-micron powdered activated carbon, pulverized ion exchange resins and coagulants. The present inventions also relate to systems and methods for concentration and removal of one or more of the combination of exhausted adsorbents.

### BACKGROUND OF THE INVENTION

Per and poly fluoroalkyl substances (“PFAS”), including their precursors and related ranges, such as perfluorooctane sulfuric acid (“PFOS”) and perfluorooctanic acid (“PFOA”), are compounds resistant to water and oil. They are man-made compounds that have been used in a wide variety of industries, including carpeting, upholstery and fire fighting foams. However, such compounds are bioaccumulative and known carcinogens and their removal from water, and particularly from ground water and drinking water, is an important environmental concern. Due to the strong fluorine-carbon bond, PFAS compounds are resistant to common treatment methods including biological and chemical oxidation.

One of the more common approaches to the removal of PFAS from water is granular activated carbon (“GAC”) or powdered activated carbon (“PAC”) treatment systems. As its name suggests, GAC uses granulated activated carbon to remove various contaminants, including organic recalcitrant compounds such as PFAS and others. In a typical GAC system, a tank contains the granulated activated carbon, the tank being of a sufficient size to retain the flow of water to be treated a sufficient time for the contaminants to react with the GAC. During the reaction, the PFAS and other organic compounds adhere to the surface of the granulated activated carbon, i.e., they are adsorbed by the granulated activated carbon.

However, it is also common for contaminated water to contain a broad range of PFAS compounds which have different sizes and characteristics for which a single adsorbent is not optimally designed. For example, a wood-based SPAC may achieve efficient removals of large PFAS compounds such as Perfluorooctanoic acid (PFOA) which has eight carbon molecules and a molecular weight of 414 g/mol. However, this wood-based SPAC may not work as efficiently on smaller PFAS molecules such as Perfluorobutanesulfonic acid (PFBS) which has only four carbon molecules an a molecular weight of only 300 g/mol. Conversely, the pore structure of a coal-based SPAC may work better on the small compounds like PFBS, but may not provide a broad range of PFAS removals like the wood-based SPAC. Chemical composition of the PFAS species also plays an important role in their relative adsorption. PFAS compounds can be cationic, anionic or zwitterionic where the molecule contains both positively and negatively charged functional groups. Perfluoroalkyl substances (PFAAs) are important terminal degradation products that can be further divided into perfluoroalkyl carboxylic acids and perfluoroalkane sulfonic acids, whose adsorptive capacities behave differently where a single adsorbent may have limited effectiveness. It may be desirable to use more than one type of SPAC material to address the different compounds present in the water.

In some cases, specialized ion exchange (IX) resins can provide a highly efficient means to remove targeted PFAS compounds. Commercial IX resins vary greatly based on their molecular structure and chemistries which can be designed to increase contaminant selectivity and provide a dual function of PFAS ion exchange and adsorption. Gel type IX resins can use a continuous polymer arrangement comprised of polystyrene crosslinked with divinylbenzene. Such resins offer high adsorptive capacity and can be regenerated with thermal and chemical treatments. Macroporous resins differ in their processing by creating larger macro pores that are beneficial when the raw water contains larger organic compounds or is subject to mechanical or thermal shocks that may limit PFAS adsorption. Most commonly, PFAS removal is achieved with anionic IX resins which offer high capacity and selectivity and are often designed for a single-use before disposal. Examples of common resins used in PFAS removal include Lewatit MonoPlus TP 109 (Lanxess), CalRes 2301 (Calgon Carbon Corporation) and Purofine® PFA694E (Purolite). It may be desirable to use more than one IX resin to treat the different species of PFAS that exist in a contaminated water source. To optimize the adsorption process, it may desirable to pulverize the IX resin into smaller sizes to increase the apparent surface area to mass relationship.

Other alternative sorbents such as certain natural or engineered materials may offer unique PFAS removal properties. There exists a wide array of adsorbents and ion exchangers including natural materials such as zeolite silicate minerals and oxidic clays that use aluminum, iron or silicon. There is also an emerging class of commercially available surface-modified clays using polymers, surfactants or amines to functionalize the medium to increase PFAS removal. Examples of such commercial products include FLURO-SORB®, RemBind® and matCARE™. They are selected due to their high surface areas, porosity and loading capacity. These mineral adsorbants may offer certain advantages, but are limited in their application at smaller sizes due to poor permeability when used in packed-bed arrangements.

It is common for adsorbents like IX and GAC to experience reduced removal efficiencies due to the presence other non-PFAS contaminants that exist in the water. For example, total organic carbon (TOC) including natural organic matter (NOM) can displace PFAS from adsorptive sites on GAC. TOC can also promote undesirable biological growth that can interfere with PFAS removal and cause premature media replacement. It is common practice to employ pre-treatment ahead of the adsorption process to remove the comingled organic compounds before removing PFAS. For example, many IX systems will use GAC as upstream pre-treatment to remove TOC. Ideally, this configuration could use multiple GAC systems in series prior to multiple IX reactors also in series.

Chemical conditioning of the influent water can also assist in the removal of comingled contaminants that may include soluble and colloidal organics and suspended solids. Coagulants such as ferric chloride or aluminum sulfate are often dosed into the influent prior to PFAS adsorption.

The ability to use multiple treatment compounds like coagulants, GAC, minerals, and IX resins can be valuable in water matrices that are high strength or include comingled contaminants. The selection of the proper treatment compounds must be made in the design stages through treatability or pilot testing. Once the decision is made and the systems are constructed, changing the mix of sorbents can be difficult and expensive.

After use, the adsorption of the organic contaminant compounds is reduced to such a point that the system is no longer effective. In other words, when the adsorption of contaminants is less than the desired treatment requirements, breakthrough is said to occur. At that point, the typical system must be shut down and the granulated activated carbon removed and properly remediated. Depending upon the contaminants filtered, the spent GAC, particularly with the adsorbed PFAS, must be hauled away and incinerated. In addition, because of the rapid breakthrough of GAC systems, and the need for frequent GAC reactivation and treatment, the operating costs for GAC treatment are relatively high. A relatively large plant footprint is also required for GAC treatment systems.

The ability of the GAC to adsorb contaminants, and the typical breakthrough time, is related to the mean particle diameter (“MPD”) of the carbon. In conventional GAC systems, the MPD is approximately 1,600 microns, but may be larger or smaller depending on the product. Improved PFAS removal effectiveness has been achieved using smaller GAC MPDs. For example, FILTRAS ORB® 400 has shown to offer improved results with a particle size ranging from 550 to 750 microns. Even in systems using PAC, the MPD of the PAC is commonly about 40 microns but PAC can be any particle that passes an 80 mesh sieve (177 microns). In adsorbents like GAC and PAC, PFAS adsorption is aided by the carbon's porous structure which includes macro-pores, micro-pores and meso-pores. The primary adsorption mechanism depends on the size of the contaminant, with macropores and mesopores having been found to be most important for PFAS removal. With the larger MPD for both GAC and PAC, access to the interior pores is limited and can result in breakthrough despite the available surface area for adsorption deep within the carbon particle. As indicated, breakthrough times are decreased with the larger MPD and carbon removal and disposal costs are increased. In addition, typical GAC systems do not as effectively remove short chain length (i.e., 4, 6 and 7 carbon chained) PFAS compounds.

Thus, there is a need to increase the removal of PFAS and other recalcitrant organic compound contaminants from water, and particularly ground and drinking water. There is also a need to increase the breakthrough time of typical GAC filtration systems and to decrease the burden and expense of used material disposal. There is also a need to increase the removal of PFAS and other recalcitrant organic contaminants from water using a variety of adsorbents such as SPAC, IX, clays and zeolites and/or coagulants, all with a single reactor.

In one embodiment of the present inventions, it has been determined that use of sub-micron powdered activated carbon (“SPAC”) and its smaller particle size provides higher surface area and increased quantity of mesopores, resulting in a lower usage rate and faster adsorption, requiring smaller volumes. SPAC is also more effective at removing short chain PFAS, for which known treatments are ineffective. The greater surface area and improved access to mesopores and macropores provided with SPAC and the present inventions has shown to increase PFAS adsorption by more than 500 times that of GAC based upon a given amount of carbon. In addition, the present inventions provide for the thickening or concentration of spent SPAC to reduce the disposal costs.

Thus, there is a need to increase the removal of PFAS and other recalcitrant organic compound contaminants from water in the presence of other comingled contaminants. There is also a need to simplify the current multi-stage treatment approach into a single treatment reactor. Finally, there is a need to support small micro-adsorbent particles below 40 microns, and preferably under 1 micron in a mixed slurry to optimize performance and reduce reaction times. In the present invention, it has been determined that the use of multiple micro-adsorbents can improve the removal efficiency of a broad-range of PFAS compounds by incorporating co-treatment within a single reactor. Targeting the removal of comingled contaminants within the same treatment reactor will increase the efficiency of specialized sorbents to improve PFAS removal at detention times as low as 2 minutes and represents a volume reduction of 10 to 30 times compared to single sorbent systems.

### SUMMARY OF THE INVENTION

Accordingly, the present inventions preserve the advantages of known PFAS removal systems and methods and also provide new features and advantages, as well as new systems and methods.

An object of the present invention is to use sub-micron powdered activated carbon (“SPAC”) to remove recalcitrant organic compound contaminants from water, the contaminants including PFAS, 1, 4-dioxane, BTEX and many others.

It is also an object of the present invention is to combine multiple sub-micron powdered activated carbon (“SPAC”) materials to remove PFAS along with pre-treatment of other organic contaminants in a single reactor.

Another object of the present invention is to provide a pressurized or non-pressurized sorption reactor to provide a detention time for the SPAC and water slurry sufficient for the SPAC to adsorb the contaminants from the influent of water to be treated.

It is also another object of the present invention is to combine other adsorbents, such as one or more IX resin to target priority compounds like PFAS and reduce the reactor's detention time.

An additional object of the present invention is to use a ceramic membrane filter, and preferably a high velocity cross-flow ceramic membrane filter, to separate the filtered water from the SPAC and/or other adsorbents with adsorbed contaminants and to return a portion of the bulk liquid to the sorption reactor.

A further object of the present invention is to increase SPAC and/or other adsorbent recovery and concentration to reduce the removal and disposal of used SPAC and/or other adsorbents.

Still an additional object of the present invention is to maintain the SPAC in a closed loop system as treated water is separated from the SPAC using high strength, high velocity cross-flow ceramic membrane filters and a bleed and feed SPAC conservation and recovery system.

Still another object of the present invention is to scour and clean the membranes of the ceramic membrane filtration system while filtering the treated water from the SPAC and its adsorbed contaminants. It may be desirable to use higher hardness particles like SPAC in combination with a lower hardness adsorbent like IX to keep the membrane surface clean.

Still a further object of the present invention is to use a ceramic membrane filter to retain SPAC in the system so that it may continue to remove soluble and recalcitrant organic compounds, including PFAS.

Yet another object of the present invention is to use a high velocity cross-flow ceramic membrane filter to reduce backwash frequency and backwash waste.

Yet a further object of the present invention is to maximize contaminant adsorption and to reduce SPAC usage and disposal.

Still yet another object of the present invention is to concentrate spent SPAC to reduce the frequency and amount of removal and/or disposal.

An additional object of the present invention is to modify the sorbent's morphology to create micro-adsorbents which are below 40 microns, and preferably below 1 micron.

A further object of the invention is to suspend all of the micro-adsorbents in a single reactor at a combined suspended solids concentration from 500 to 100,000 mg/L.

Yet another object of the invention can use a combination of micro-adsorbents in either a single-stage system or a two-stage system which is operated in series using a single treatment reactor.

Yet a further object of the invention combines a coagulant with the micro-adsorbent mixture to improve the water quality and promote adsorption of priority compounds like PFAS.

Still another object of the present invention is to separate the treated water from the micro-adsorbent slurry with a ceramic membrane having a nominal pore size of approximately 0.1 micron.

Still yet another object of the invention permits the combination of sorbent materials and coagulants to be pre-made.

Still yet a further object of the invention uses separate sorbent feed pumps and stock sorbent containers to customize the mixture to address changing influent water characteristics.

Still yet an additional object of the present invention is to use a horizontal or vertical sorption reactor that may be pressurized or nonpressurized.

Still yet another objective of the invention is to introduce the sorbent mixture to the sorption reactor with a high velocity jet mixing nozzle in proximity of the water influent but at the end opposite of the sorption reactor outlet.

In accordance with the objects of the present invention, a method for removing contaminants from water is provided. The steps include: adding sub-micron powdered activated carbon (SPAC) to an influent flow of water to be treated; combining the SPAC with the water to be treated; introducing a SPAC and water mixture or slurry into a sorption reactor for treatment; permitting the mixture to remain in the sorption reactor for a sufficient detention time for the SPAC to adsorb contaminants in the water; and transferring the mixture or slurry from the sorption reactor using a recycle pump to a high velocity ceramic membrane filter unit operating in cross-flow filtration wherein the treated water is discharged as permeate and the SPAC slurry is returned to the sorption reactor as retentate. The method may also include removing the SPAC and adsorbed contaminant concentrate from the ceramic membrane filter via a concentrate line upon the SPAC reaching breakthrough; and adding new SPAC to the influent flow of water to continue contaminant removal. Further, in a preferred method, the SPAC and adsorbed contaminants are thickened for removal by terminating the influent flow to the sorption reactor and continuing operation of the recycle pump until the retentate is thickened and is thereafter removed via the concentrate line for disposal. The membranes of the ceramic membrane filter have a nominal pore size barrier of approximately 0.1 microns. In a preferred method, the influent flow is 1 Qi and the mixture of SPAC and influent is pumped at 10 times the influent (10 Qi) from the sorption reactor to the ceramic membrane filter. Also as preferred, the permeate is discharged at a rate of 1 times the influent flow (1Qi) from the ceramic membrane filter and the retentate is returned to the sorption reactor at a rate of Qr, which is preferably 9 times the influent flow (9 Qi). Preferably, the SPAC has a mean particle diameter below approximately 1 micron.

Also provided is a system for removing contaminants, including PFAS, from water. The system includes: a pressurized or non-pressurized sorption reactor in fluid communication with an influent line, and a SPAC feed line in communication with the influent line to add SPAC to the influent, the sorption reactor receiving an influent flow of water to be treated and sub-micron powdered activated carbon (SPAC), the sorption reactor capable of retaining the influent and SPAC slurry a sufficient retention time so that the contaminants to be removed are adsorbed by the SPAC in the slurry; a slurry effluent line in communication with a discharge of the sorption reactor and a recycle pump in the slurry effluent line; a cross-flow ceramic membrane filter in fluid communication with the slurry effluent line of the sorption reactor, the recycle pump transferring the SPAC with adsorbed contaminants at a high flow rate to the ceramic membrane filter unit which separates treated water from the contaminant-adsorbed SPAC as permeate; a permeate line in fluid communication with the ceramic membrane filter for removing the treated water as permeate; a retentate line in fluid communication with the ceramic membrane filter and the sorption reactor to return the SPAC slurry to the influent line; and a concentrate line for removing SPAC upon breakthrough. The preferred system uses SPAC that has a mean particle diameter below approximately 1 micron on wherein the ceramic membrane filter has a nominal pore size barrier of approximately 0.1 micron. An embodiment of the system may also include a SPAC feed system in fluid communication with the influent line.

A system and method for removing multiple contaminants from water is also provided, the method including the steps of: adding multiple adsorbents to an influent flow of water to be treated; combining the multiple adsorbents with the water to be treated; introducing the adsorbents and water mixture into a single sorption reactor for treatment; and, transferring the mixture from the sorbent reactor using a recycle pump to a ceramic membrane filter unit operating in cross-flow filtration wherein the treated water is discharged as permeate and the multiple adsorbent mixture is returned to the sorption reactor as retentate. The multiple adsorbents may include more than one adsorbent type and can include any combination of various sizes of SPAC, IX resin or adsorptive clays. It is preferred that each of the multiple adsorbents have a mean particle diameter below 40 microns and the detention time of the reactor is between 2 and 30 minutes.

A coagulant may also be added to the influent flow to improve the sorbent and membrane performance. In addition, the sorbent mixture held in the reactor is maintained between 500 and 100,000 mg/L. The multiple adsorbents may be added to the system individually. As preferred, the multiple adsorbents are pre-mixed and added to the system as a mixture.

### Inventor's Definition of the Terms

The following terms which may be used in the various claims and/or specification of this patent are intended to have their broadest meaning consistent with the requirements of law:

“Influent” or “influent flow” (also referred to as Qi) as used herein refers to the liquid (water or wastewater) to be treated that is introduced into the contaminant removal system.

“Permeate” or “filtrate” as used herein shall refer to the treated fluid or fluid flow after treatment with the contaminant removal system and separation of the SPAC and/or other adsorbants and its adsorbed contaminants.

“Retentate” or “retentate flow (Qr)” as used herein refers to the SPAC containing bulk liquid or slurry from which the permeate or filtrate has been removed.

“SPAC” as used herein refers to sub-micron, or super-fine powdered activated carbon, preferably wood based, and preferably with a mean particle diameter below approximately 1 micron, although other SPAC types and diameters are acceptable.

“PFAS” as used herein refer to a broad range of per or poly fluoroalkyl substances, including perflourooctane sulfonic acid (PFOS) and perflourooctanoic acid (PFOA), as well as short chain perflouroalkyl acids (PFAA) and its precursers. PFAS as used herein may also refer generally to other recalcitrant organic compounds.

“Breakthrough” as used herein refers to the SPAC and/or other adsorbants that is no longer capable of adsorbing sufficient levels of contaminants for desired and effective treatment.

“IX” as used herein refers to ion exchange resins which are polymers than can be functionalized as anionic, non-ionic or cationic as necessary to remove contaminants from water.

“Micro-adsorbent” as used herein refers to any adsorbent material in which the mean particle diameter is smaller than 40 microns.

“Total Organic Carbon” or “TOC” used herein refers to a class of organic pollutants which can interfere with effective adsorption and removal of certain priority pollutants like PFAS.

“Pre-treatment” as used herein refers to the use of chemicals, coagulants, filters or adsorbents to remove non-targeted pollutants, like TOC, prior to treatment for removal of targeted pollutants like PFAS or other micro-pollutants.

Where alternative meanings are possible, in either the specification or claims, the broadest meaning is intended consistent with the understanding of those of ordinary skill in the art. All words used in the claims are intended to be used in the normal, customary usage of grammar, the trade and the English language.

### BRIEF DESCRIPTION OF THE DRAWINGS

The stated and unstated objects, features and advantages of the present inventions (sometimes used in the singular, but not excluding the plural) will become apparent from the following descriptions and drawings, wherein like reference numerals represent like elements in the various views, and in which:

FIG. 1 is a schematic view of the preferred contaminant removal system of the present invention in its basic form.

FIG. 1A is a schematic view of an alternate preferred contamination removal system of the present invention showing the potential addition of other adsorbants with separate optional mixers and feed lines, the slurry feed line and retentate line entering the sorption reactor at the bottom of the sorption reactor, and the slurry effluent line exiting at the top of the reactor.

FIG. 1B is the contaminant removal system of FIG. 1 wherein the slurry feed line and retentate line are introduced at the bottom of the sorption reactor and the slurry effluent line exits at the top of the sorption reactor

FIG. 1C is a schematic view of a preferred contaminant removal system of the present invention showing a tote with an optional mixer and a single slurry feed line for the introduction of one or more combined adsorbents.

FIG. 2 is a schematic view of a more comprehensive preferred contaminant removal system of the present invention.

FIG. 2A is a schematic view of an alternate preferred contamination removal system of the present invention showing the potential addition of other adsorbants with separate optional mixers and feed lines, the slurry feed line and retentate line entering the sorption reactor at the bottom of the sorption reactor, and the slurry effluent line exiting at the top of the reactor.

FIG. 2B is the contaminant removal system of FIG. 1 wherein the slurry feed line and retentate line are introduced at the bottom of the sorption reactor and the slurry effluent line exits at the top of the sorption reactor

FIG. 2C is a schematic view of a preferred contaminant removal system of the present invention showing a tote with an optional mixer and a single slurry feed line for the introduction of one or more combined adsorbents.

### DETAILED DESCRIPTION OF PREFERRED EMBODIMENTS

Set forth below is a description of what is currently believed to be the preferred embodiments or best representative examples of the inventions claimed. Future and present alternatives and modifications to the embodiments and preferred embodiments are contemplated. Any alternatives or modifications which make insubstantial changes in function, purpose, structure or result are intended to be covered by the claims of this patent.

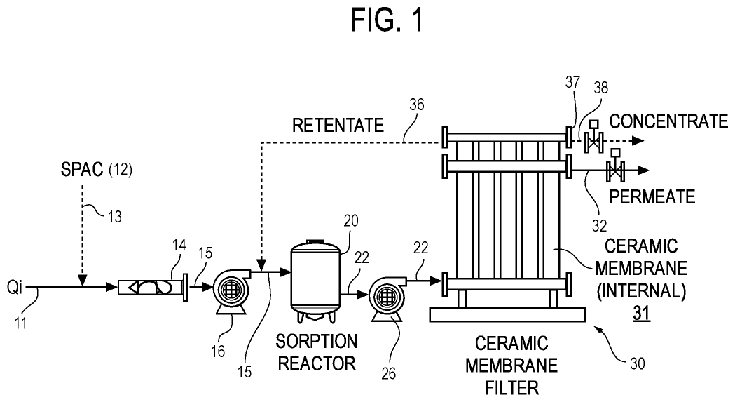

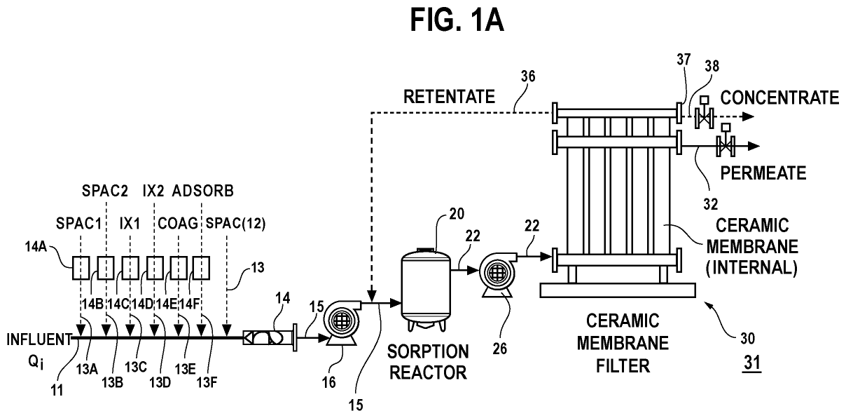

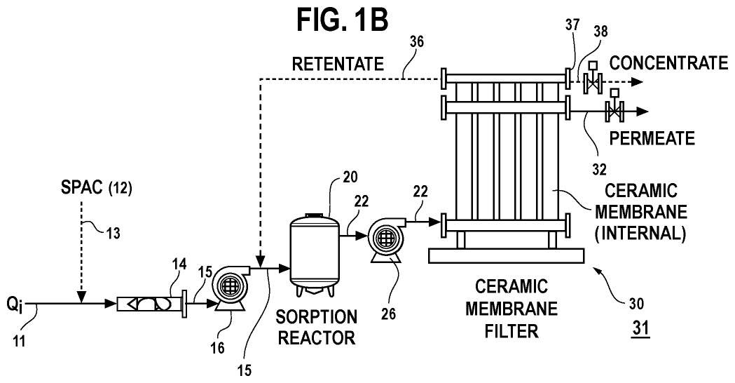

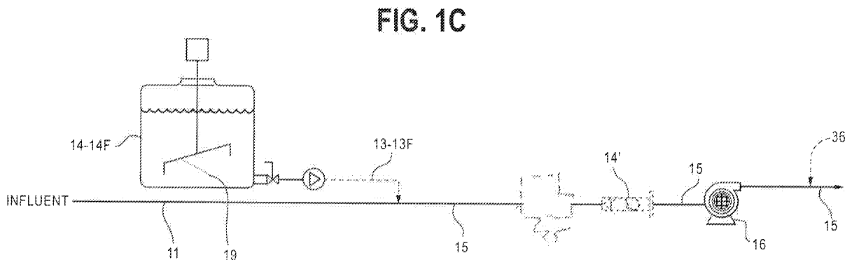

A preferred PFAS removal system and method of the present inventions is shown in its basic form in FIG. 1. The system includes an influent line 11 that introduces the flow (Qi) of influent of water to be treated into the system. SPAC 12 is added to the influent (Qi) via a SPAC feed line 13, typically using a carbon feed assembly or other means as hereinafter described. A mixer 14 may optionally be included to help mix the influent water and the SPAC 12 forming the bulk liquid or slurry to be treated. The SPAC 12 and influent slurry is then pumped by a feed pump 16 through slurry feed line 15 to a sorption reactor 20. Feed pump 16 is sized to pump the influent flow and SPAC slurry at a designed flow rate (Qi). Feed pump 16 pumps the influent at Qi with the SPAC slurry to sorption reactor 20 via slurry feed line 15.

In a preferred embodiment, the systems and method utilize a wood based SPAC 12 having a mean particle diameter (MPD) below approximately 1 micron. The use of the sub-micron powdered particles provides a higher exterior surface area per unit mass and increased quantity of and access to mesospores contained in the particles to permit faster, more effective contaminant adsorption. It also permits greater contaminant exposure and a lower ratio of usage. As a result, it has proven effective in, among other things, short chain PFAS removal.

SPAC 12 is a commercially available material. It may be readily manufactured from GAC and/or PAC, of which there are many known manufacturers as will be understood by those of skill in the art. The sources and sizes of SPAC of the present inventions are readily available to those of skill in the art.

In a preferred embodiment, the SPAC 12 will be manufactured and shipped to the treatment site in a liquid slurry for ease of handling and ultimate use. For example, a 10% slurry of 1 micron SPAC and water (100 grams of Carbon/liter) has been found to be desirable for use in the present inventions. Similarly, a 30% slurry of 1 micron SPAC and water (300 grams of carbon/liter) has also been found effective. A 10%-30% slurry is acceptable for this form of the present inventions. As hereinafter described, the original SPAC 12 slurry is further diluted by the influent water to be treated to the working concentration to be transferred to the sorption reactor 20. In a preferred embodiment where the SPAC slurry is 100 grams of carbon/liter, the slurry is diluted to approximately 0.5 to 2 grams of carbon/liter in the sorption reactor 20. In some embodiments of the present invention, a slurry of 0.5 to 100 grams/liter may be acceptable. These concentrations are merely illustrative and not limitations.

Sorption reactor 20 is the vessel in which, among other things, the water to be treated is in contact with the SPAC 12 or SPAC slurry a sufficient time so that the PFAS may be adsorbed by the SPAC 12. The sorption tank 20 serves as a reaction chamber for the SPAC 12 and water to be treated such that the PFAS and other contaminants are adsorbed by the SPAC 12 in the sorption tank 20. The sorption reactor 20 provides a desired and/or designed detention time of the SPAC/influent slurry such that the PFAS and other contaminants may be sufficiently adsorbed by the SPAC 12. The sorption reactor 20 geometry is designed to provide a maximum distance from influent to discharge and can be arranged in a vertical or horizontal orientation. For example, influent to sorption reactor 20 from slurry feed line 15 should be located the greatest distance from the effluent from sorption reactor 20 through effluent line 22. In the preferred configuration, the retentate line 36 terminates in the sorption tank 20 with a discharge that is oriented to maximize mixing of the SPAC/influent slurry before exiting the tank through effluent line 22. In the preferred method, the SPAC/influent slurry is introduced to the sorbent reactor 20 in a manner that generates an Archemedian spiral that promotes mixing and reduces short circuiting of the mixture before being discharged through effluent line 22. In the preferred embodiment, the introduction of flow to sorption tank 20 through retentate line 36 is performed at a sufficiently high velocity through the use of a jet nozzle or pipe diameter reduction to improve mixing, although other means of flow introduction known in the art may be employed. Further, the slurry feed line 15 may be separately connected to sorbent reactor 20, but should be discharged in direct proximity to the retentate 36 discharge to promote mixing of the two flow streams.

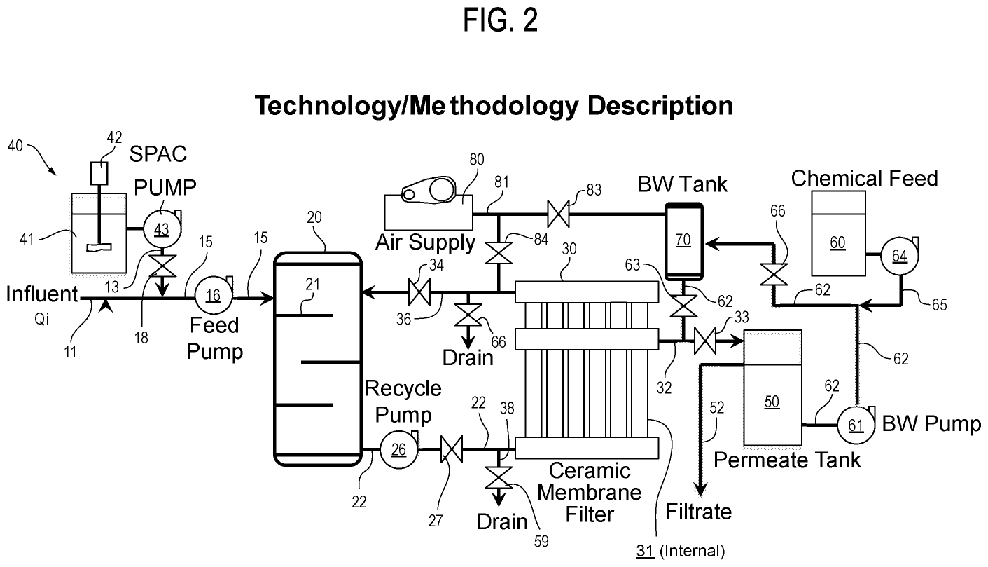

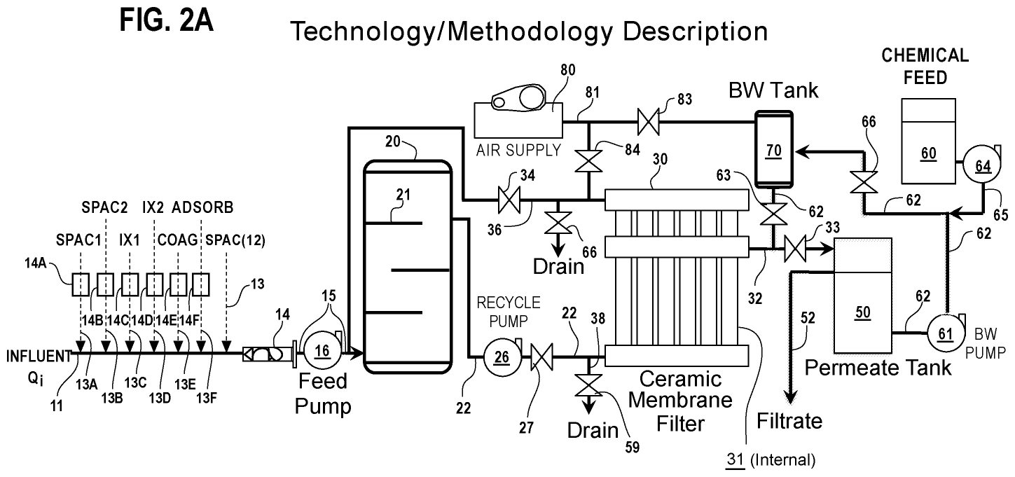

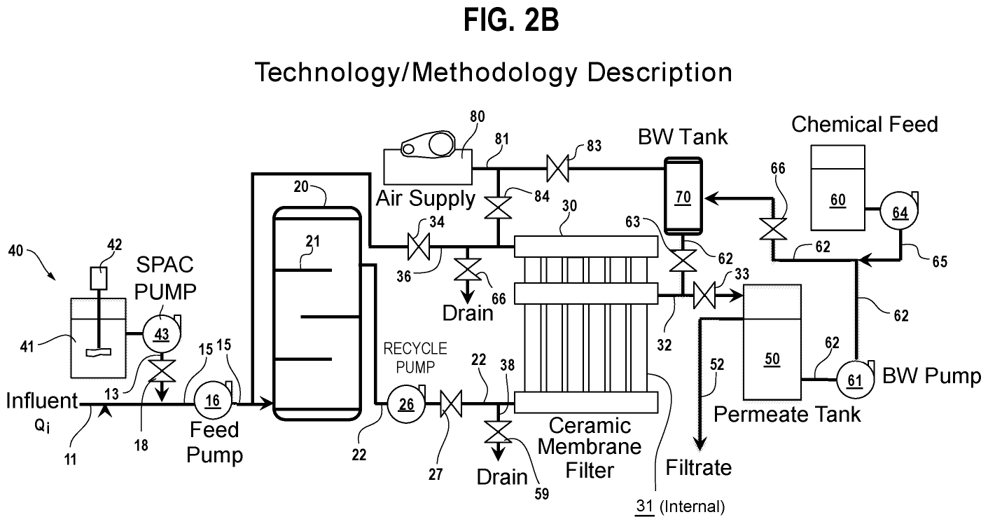

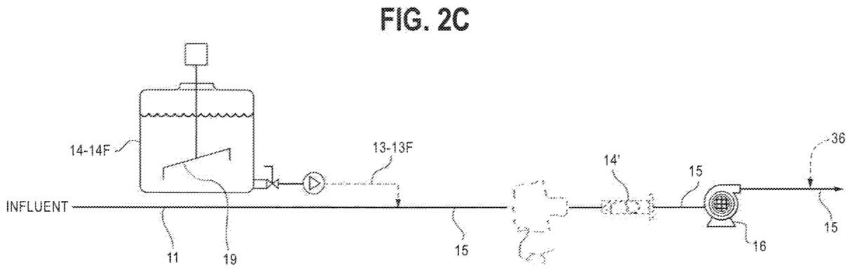

In a preferred embodiment, the sorption reactor 20 is sized to accommodate at least ten times the influent flow (10Qi) as hereinafter described. It will be understood by those of skill in the art that sorption reactor 20 is also sized to provide a desired detention time to aid the SPAC's adsorption of PFAS and other contaminants. The larger the sorption reactor 20 at a given flow, the longer the detention time it is capable of providing. In a preferred embodiment, a detention time of between 30-60 minutes at the influent flow (Qi) has been determined to be satisfactory for the reaction between the SPAC and the PFAS in the influent having an exemplary influent from (Qi) of 100 gallons/minute. Other detention times will also suffice depending upon the desired treatment parameters and influent flows. For example, as hereinafter described, in embodiments utilizing multiple sorbents (see FIGS. 1A and 2A), retention time can be reduced to between 2 and 30 minutes, and preferably between 2 and 10 minutes. As above, in a system where Qi is 100 gallons/minute and a detention time in sorption reactor 20 is one hour, sorption reactor 20 must accommodate at least 6,000 gallons. However, in the multiple sorbent embodiments of the present inventions, the sorption reactor 20 may be reduced from 6,000 to as little as 200 gallons.

One preferred sorption reactor 20 of the present invention is a pressurized tank that may be closed to the atmosphere. To prevent short-circuiting, baffles 21 (see FIG. 2) may be included in the sorption reactor 20. It will be understood by those of skill in the art that non-pressurized tanks may be utilized. However, such tanks would have to be relatively tall and/or would require a substantially larger energy requirement. In an alternative embodiment of the present invention, sorption reactor 20 may be horizontal, i.e., long and narrow and preferably open topped or non-pressurized.

The SPAC adsorbs the PFAS and other contaminants in sorption reactor 20. After sufficient detention time in the sorption reactor 20, the SPAC and bulk liquid reacted slurry is then pumped via slurry effluent line 22 to a ceramic membrane filter unit 30 using a recycle pump 26. In the preferred embodiment, the recycle pump 26 is sized to pump ten times the influent flow (10Qi) through slurry effluent line 22 to ceramic membrane filter 30.

The ceramic membrane filter unit 30 provides important unique functions of the present inventions. First, the ceramic membrane filter 30 separates the SPAC and adsorbed contaminants from the treated liquid to be removed as clean permeate via permeate line 32. The ceramic membrane filter also returns SPAC slurry to the sorption reactor 20 for further treatment of influent which reduces SPAC consumption. Third, the ceramic membrane filter 30 also serves to concentrate and thicken the SPAC 12 upon approaching breakthrough or exhaustion that aids in SPAC 12 disposal, without the need for complicated additional equipment.

In one preferred embodiment, the ceramic membrane filter 30 has a 0.1 micron nominal pore size barrier. The small pore size results in high permeability and reduced pressure loss across each membrane of the ceramic membrane filter 30. As will be understood by those of skill in the art, suitable ceramic membrane filters 30 are available from a number of vendors, including Aqua-Aerobic Systems, Inc. (see www.aqua-aerobic.com).

In the preferred embodiment, the ceramic membrane filter 30 is operated in cross-flow filtration mode. As preferred, recycle pump 26 sends the SPAC/liquid slurry to the ceramic membrane filter 30 via slurry effluent line 22 at 10 times the influent flow rate or 10 Qi. The membranes of the ceramic membrane filter 30 separate the treated liquid from the SPAC and liquid slurry. The treated water is discharged as permeate via permeate line 32, preferably at the approximate rate of the initial influent rate of flow Qi. The SPAC and bulk liquid not discharged as permeate is discharged from ceramic membrane filter 30 as retentate (Qr) via retentate line 36, preferably at the rate of 9 times the initial flow or 9 Qi. The retentate is returned upstream of the sorption reactor 20, either to slurry feed line 15 or directly to sorption reactor 20. Among other things, the return of the SPAC laden retentate slurry increases the concentration of SPAC 12 in the sorption reactor 20, thereby requiring less virgin SPAC 12 to be added to the system. This also facilitates enhanced PFAS adsorption by the SPAC 12. Ceramic membrane filter 30 is also provided with a concentrate exit 37 in fluid communication with concentrate removal line 38 to remove spent SPAC 12 after breakthrough.

Importantly, pumping high velocity slurry at 10 Qi to the ceramic membrane filter 30, while only removing 1 Qi as permeate, scours the membranes 31 inside the ceramic membrane filter 30. This results in maintaining clean membranes 31 and a high permeability of the membranes 31. It also reduces the frequency of backwashing requirements. The high velocity through the ceramic membrane filter 30 further reduces the opportunity for bio-growth, which helps maintain filtering efficiency and reduces the need for frequent backwashing or chemical conditioning. In the preferred embodiment, where 10Q is pumped 26 to the ceramic membrane filter 30, 1 Qi is removed as permeate via permeate line 32. As a result, 9Q (9Qr) is returned to the sorption reactor 20 as retentate via retentate line 36. It will be understood by those of skill in the art that these flows are exemplary and/or preferred and that other rates may be used consistent with the present inventions. When in slurry form, the relative hardness of the sorbent material can affect the membranes performance. SPAC, for example, has a Mohs hardness of 2-3 compared to a value of 9 for ceramic membranes. When circulated across the membrane's surface with sufficient velocity, the SPAC can scour the membrane thereby preventing the accumulation of foulant materials. The relative hardness of the two materials keeps pressures low and hydraulic capacities high. Conversely, plastic beads such has polystyrene offer a much lower hardness value and would not offer as much benefit. It may be desirable to use harder adsorbents like SPAC or certain minerals in conjunction with softer sorbents like IX resins to obtain benefit in both PFAS removal and hydraulic throughput.

The foregoing describes the basic system and method for PFAS removal using SPAC, the sorption reactor 20 and a ceramic membrane filter 30 of the present inventions. In addition, a more comprehensive system of the present inventions is described herein by reference to FIG. 2. The system and method of SPAC thickening and removal is also described by reference to FIG. 2, although thickening and removal is also part of the basic system shown in FIG. 1.

As shown in FIG. 2, a SPAC feed system 40 is provided as a substitute for the direct feed of SPAC 12 to influent line 11 and the use of optional mixer 14. The SPAC feed system 40 includes a tank 41 and a mixer 42 that mixes the SPAC slurry for use in the system. Specifically, in the preferred embodiment, a 10% SPAC slurry (e.g., 100 grams of carbon/liter) is added to tank 41 and mixed by mixer 42. The SPAC slurry is pumped from tank 41 using SPAC feed pump 43 through SPAC feed line 13 to influent line 11. The mixture or slurry, via slurry feed line 15, is then pumped using feed pump 16 to the sorption reactor 20, preferably at a rate of Qi. In a preferred embodiment, the 10% SPAC concentration is diluted to approximately 0.5-2 grams of carbon/liter in the sorption reactor 20. As shown schematically, a preferred sorption reactor 20 includes one or more baffles 21 to help prevent short-circuiting. Upon sufficient detention time for the SPAC 12 to adsorb the contaminants, the bulk liquid is pumped to ceramic membrane filter 30 via slurry effluent line 22 and recycle pump 26. Again, the preferred pumping is at 10 Qi into the ceramic membrane filter 30 and recycle pump 26 sized accordingly.

In yet other preferred embodiments of the present invention, a variety of adsorbents may be added to the influent flow depending upon the contaminants in the influent to be treated. See FIGS. 1A and 2A. For example, FIG. 1A shows the potential introduction of up to five additional adsorbents, and a specialty adsorbent mixture, in addition to (or in lieu of) the original SPAC (12).

For example, there may be SPAC (1) of a different type or size of SPAC (12) introduced via line 13A which may include optional mixer 14A. A third type or size of SPAC (2) may be introduced via line 13B which may include optional mixer 14(b). Thus, depending upon the influent to be treated, SPAC (12), SPAC (1) and/or SPAC (2) may be introduced to influent line 11 and slurry feed line 15.

In lieu of or in addition to the different types or sizes of SPAC, one or more types or sizes of ion exchange resins (IX) may be introduced. For example, IX1 may be introduced through line 13C and may include optional mixer 14C. A second type or size of ion exchange resin IX2 may be added to the influent line 11 via line 13D and may include optional mixer 14D. In addition, it may be desirable to add coagulants, with or without other adsorbents, depending upon the influent to be treated. If desired, coagulant COAG may be added to influent line 11 via line 13E and may include optional mixer 14E. In a preferred embodiment, another adsorbent or a mixture of adsorbents may be added to the influent line 11. The adsorbent or mixture, referred to as ADSORB in FIGS. 1A and 2A, is tailored to the type of influent to be treated. ADSORB may be introduced through line 13F and may include optional mixer 14F. ADSORB may include, among other things, a mix of SPACs, IX resins and/or COAGs, which may be supplied via one feed line 14F to the influent line 11.

Optionally, in lieu of the feed lines 13A-13F for each adsorbent and separate optional mixers 14A-14F, a single tote shown as 14-14F in FIGS. 1C and 2C may be used. Tote 14-14F may also include optional mixer 19 and would have one feed line labelled as 13-13F in FIGS. 1C and 2C to slurry feed line 15. Optional inline mixer 14′ may also be provided.

In this embodiment, the adsorbent mixture may be pre-combined or pre-mixed depending upon the influent. The combined adsorbent is then fed to slurry feed line 15 via influent line 11. In yet another alternative embodiment (without optional mixer 14′), an optional high velocity jet mixing nozzle 25 may be used to mix the adsorbents as part of the influent (see FIGS. 1C and 2C) in proximity to the influent of slurry feed line 15 of sorption reactor 20. The system and method thereafter operates as discussed.

In various preferred embodiments, it has also been determined that it is desirable to have slurry feed line 15 enter sorption reactor 20 near the bottom of the reactor as shown in FIGS. 1A and 2A. In addition, retentate line 36 is preferably in fluid communication with slurry feed line 15 so that it also is introduced near the bottom of sorption reactor 20. It is also preferred that slurry effluent line 22 exits near the top of horizontal sorption reactor 20, also as shown in FIGS. 1A and 2A.

FIGS. 1 and 2 show slurry feed line 15 introduced near the top of sorption reactor 20, retentate line introduced near the top of reactor 20 and slurry effluent line 22 exiting near the bottom of sorption reactor 20. In other preferred embodiments, with or without the additional adsorbent feeds, slurry feed line 15 and retentate line 36 may be introduced near the bottom of sorption reactor 20 and slurry effluent line 22 may exit near the top of reactor 20 as shown in FIGS. 1B and 2B and 1A and 2A.

It has also been determined that sorption reactor 20 may be horizontal or use other tank geometries. Sorption reactor 20 may also be open topped, closed topped and/or pressurized.

As with the embodiment of FIG. 1, the ceramic membrane filter 30 separates the permeate from the SPAC 12 (or other adsorbents) and its adsorbed contaminants. The permeate is removed from the ceramic membrane filter 30 at a rate of 1 Qi via permeate line 32. In this embodiment, however, a permeate tank 50 is provided that is in fluid communication with permeate line 32. Permeate from ceramic membrane filter 30 is transferred to the permeate tank 50 and may be removed via permeate drain 52 as treated effluent or stored for use in backwashing as hereinafter described.

In the embodiment of FIG. 2, a backwash line 62 is in fluid communication with permeate tank 50 for removal of permeate for use in backwashing. A backwash pump 61 is also provided in backwash line 62. Backwash line 62 is in fluid communication with a backwash tank 70. Backwash tank 70 is then in fluid communication with permeate line 32 of the ceramic filter membrane unit 30. When backwashing is desired or required, permeate is pumped from permeate tank 50 by backwash pump 61 to backwash tank 70. The permeate from backwash tank 70 flows from backwash line 62 to permeate line 32 which communications with the ceramic membrane filter 30. This reverses flow through the ceramic membrane filter 30 to backwash the membranes 31 as hereinafter described.

An optional chemical feed tank 60 may also be provided. Chemical feed tank 60 is in fluid communication with chemical feed line 65, which includes a chemical feed pump 64. Chemical feed line 65 is in turn in communication with backwash line 62. Chemical feed tank 60 contains a solution of chemicals that may be used when backwashing the membranes of ceramic membrane filter 30. Such chemicals may include NaOCl and citric acid to aid in cleaning the membranes. Other chemicals may be used as understood by those of skill in the art. Thus, when chemicals are desired for use in backwashing, the chemical solution is pumped by chemical feed pump 64, through chemical feed line 65 and into the permeate flow of backwash line 62.

In addition, an optional air supply 80 may be provided. Air supply 80 is in fluid communication with an air supply line 81. Air supply line 81 is in fluid communication with backwash tank 70 and retentate line 36. Air supply 80 may be provided in certain systems for use in backwashing. When backwashing is desired, air supply 80 pressurizes backwash tank 70 through air supply line 81 until a pressure setting is reached and then air valve 83 closes. Then backwash valve 63 is opened and releases the pressurized permeate from the backwash tank 70 through membrane filter 30 to help clean the membranes 31.

An important aspect of the present inventions is the thickening, dewatering and removal of the spent SPAC 12. A preferred system and method will be described by reference to FIG. 2. For PFAS and other organic contaminant removal, a flow of influent at a rate of Qi is introduced at influent line 11 (e.g., 100 gallons/minute). Using SPAC feed pump 43, the SPAC solution (e.g., 100 grams of carbon/liter) is pumped from SPAC tank 41 through an open SPAC feed valve 18 via SPAC feed line 13. The influent and SPAC slurry is pumped by feed pump 16 to sorption tank 20 via slurry feed line 15. The slurry is pumped into sorption reactor 20 at a rate of Qi. The SPAC 12 and influent slurry are detained in sorption reactor 20 for the desired retention time, whereby the PFAS and other contaminants are adsorbed into the SPAC 12. The concentration of SPAC 12 slurry in the sorption reactor 20 may be an exemplary 0.5-2 grams of carbon/liter.

The SPAC with adsorbed contaminants and bulk liquid slurry is transferred from sorption reactor 20 to the ceramic membrane filter 30 for filtration. Specifically, the slurry is pumped using recycle pump 26 along slurry effluent line 22, through open recycle valve 27 into the ceramic membrane filter 30. As previously discussed, recycle pump 26 is sized to pump 10 times the influent flow (10 Qi) into the ceramic membrane filter 30. The membranes of the ceramic membrane filter 30 separate the permeate from the SPAC/influent slurry.

The permeate is discharged from ceramic membrane filter 30 via permeate line 32 through open permeate valve 33 and into permeate tank 50 where it may be removed via permeate removal line 52. The retentate is removed from ceramic membrane filter 30 through retentate line 36 and open retentate valve 34 to be returned to sorption reactor 20. The retentate is returned to the sorption reactor 20 at a flow rate of Qr, which is 9 times the influent flow, or 9 Qi. During the typical filtration operation, backwash pump 51 is off, backwash valve 63 is closed and air supply valves 83, 84 are closed.

As indicated, an important aspect of the present inventions is the dewatering, thickening and removal of the spent SPAC 12 (and its adsorbed contaminants). When the SPAC has reached breakthrough, the influent flow into the system is shut off, feed pump 16 is off and SPAC feed valve 18 closed. Recycle pump 26 continues to operate and pumps the slurry at a rate of 10 Qi from sorption reactor 20. During the dewatering process, ceramic membrane filter 30 continues to remove permeate at a flow rate of 1 Qi and retentate continues to be returned to sorption reactor 20 at a rate of 9 Qi. After a certain amount of time, which is based upon the size (retention time) of the sorption reactor 20, the exhausted SPAC is sufficiently dewatered and concentrated to be removed for disposal. The desired concentration of SPAC 12 slurry when removed is, as an example, 10 grams of carbon/liter. If the concentration is too high, it is difficult to remove from the system.

It should also be noted that in practice, when concentrating the retentate for removal, after the influent flow Qi to the sorption reactor 20 is shut down, permeate is typically not removed at the full desired rate of 1Q for the entire process. Instead, it is ramped down to less than 1Q so that the retentate does not become too thick or concentrated for effective removal from the system.

When backwashing the membranes of the ceramic membrane filter 30 is required, the influent flow as described above for dewatering is halted. Recycle pump 26 is off and drain valve 39 is open. Permeate valve 33 is closed and backwash valve 63 and 66 are open. Backwash pump 61 is activated, drawing permeate from permeate tank 50. The permeate flows along backwash line 62 to backwash tank 70. If desired, chemicals may be added to the permeate along backwash line 62 via chemical feed line 65. The permeate or chemically enhanced permeate flows from backwash line 62 into permeate line 32 in a reverse flow from the permeate. The backwashed permeate goes through the ceramic membrane filter 30 in a reverse direction from filtration. The backwash liquid reverse flows to slurry effluent line 22 and is removed through open drain valve 59.

The above description is not intended to limit the meaning of the words used in or the scope of the following claims that define the invention. Rather, it is contemplated that future modifications in structure, function or result will exist that are not substantial changes and that all such insubstantial changes in what is claimed are intended to be covered by the claims. Thus, while preferred embodiments of the present inventions have been illustrated and described, it will be understood that changes and modifications can be made without departing from the claimed invention. In addition, although the term “claimed invention” or “present invention” is sometimes used herein in the singular, it will be understood that there are a plurality of inventions as described and claimed.

Various features of the present inventions are set forth in the following claims.

What is claimed is:

1. A method for removing contaminants from water comprising the steps of:
adding multiple adsorbents to an influent flow of water to be treated;
combining the multiple adsorbents with the water to be treated;
introducing the adsorbents and water mixture into a single sorption reactor for treatment;
transferring the mixture from the sorbent reactor using a recycle pump to a ceramic membrane filter unit operating in cross-flow filtration wherein the treated water is discharged as permeate and the multiple adsorbent mixture is returned to the sorption reactor as retentate.

2. The method of claim 1 wherein the multiple adsorbents include more than adsorbent type.

3. The method of claim 1 wherein the adsorbent types can include any combination of SPAC, IX resin or adsorptive clays.

4. The method of claim 1 wherein each of the multiple adsorbents have a mean particle diameter below 40 microns.

5. The method of claim 1 wherein the detention time is between 2 and 30 minutes.

6. The method of claim 1 wherein a coagulant may be added to the influent flow to improve the sorbent and membrane performance.

7. The method of claim 1 wherein the sorbent mixture held in the reactor is maintained between 500 and 100,000 mg/L.

8. The method of claim 2 wherein the multiple adsorbents are added to the system individually.

9. The method of claim 2 wherein the multiple adsorbents are pre-mixed and added to the system as a mixture.
